(19) United States
(12) Patent Application Publication
(10) Pub. No.: US 2011/0114505 A1
(43) Pub. Date: May 19, 2011

(54) SYSTEM AND METHOD FOR FUSING HYDROGEN INTO HELIUM

(76) Inventor: Paul Elliot Schur, North Salem, NY (US)

(21) Appl. No.: 12/791,713

(22) Filed: Jun. 1, 2010

Related U.S. Application Data
(60) Provisional application No. 61/184,303, filed on Jun. 4, 2009.

(51) Int. Cl. C25B 1/04; C25B 9/00; B01J 19/08

(52) U.S. Cl. 205/637; 422/186.04

(57) ABSTRACT

A system, method and apparatus for achieving an energy gain through fusion by removing electrons from a hydrogen atom prior to initiating fusion, including an electrolysis unit configured to manufacture hydrogen from water; an ionization chamber coupled to the electrolysis unit and configured to separate electrons from the manufactured hydrogen, wherein the electrons are separated from protons in a nucleus of a hydrogen atom; a proton collection chamber coupled to the ionization chamber and configured to collect the protons in a resting state; and a fusion chamber coupled to the proton collection chamber and configured to emit electromagnetic radiation on the collected protons to achieve fusion and an energy gain.

### CROSS REFERENCE TO RELATED APPLICATIONS

The present invention claims benefit of priority to U.S. Provisional Patent Application Ser. No. 61/184,303 of Paul Elliot SCHUR, entitled “SYSTEM AND METHOD FOR FUSING HYDROGEN INTO HELIUM,” filed on Jun. 4, 2009, the entire disclosure of which is hereby incorporated by reference herein.

### BACKGROUND OF THE INVENTION

1. Field of the Invention

The present invention generally relates to systems and methods for the fusion of hydrogen, and more particularly to a method and system for fusion of hydrogen into helium by removing electrons from protons in a hydrogen atom and by using water as a source of the hydrogen and for achieving an energy gain.

2. Discussion of the Background

Currently our nation, our world, and our way of life are in peril from several perspectives, including economic, environmental, and global stability. The best solution to our current and future problems lies in technological innovation in the energy industry. Controlled nuclear fusion is much safer, more efficient, and less expensive per kilowatt-hour to produce than fission. Nuclear fusion occurs naturally in stars and is the source of energy for our sun. Scientists have achieved fusion, but it has never resulted in an energy gain that can be utilized or explained. Though the scientific community claims a consistent useful energy supply from fusion is decades away from reality, many scientists now believe it is possible and some even acknowledge that a gain has been achieved. When it is achieved correctly in a useful fashion, controlled nuclear fusion can release a substantial amount of energy resulting in a significant energy gain and advantageously without leaving a substantial carbon footprint.

The scientific community generally takes two different approaches to fusion. First, some have sought to achieve energy gains through fusion by simulating the high level of energies that exist in the sun. Trying to duplicate this level of speed and energy here on earth is not necessary to achieve an energy gain through fusion and indeed hinders the process. Fusion scientists have only been working with heavy concentrations of the hydrogen isotopes (i.e., deuterium and tritium) instead of the hydrogen element itself that can be found in water. This approach also necessitates an extremely cumbersome and expensive process. Deuterium can be separated from the hydrogen element and tritium has to be manufactured from lithium. Lithium is a rare element and is needed for lithium batteries, which are the “new future” in the auto industry. In fifty years scientists have not yet achieved a gain from this approach to fusion. Deuterium and tritium do not maximize the possible energy gain in the conversion of mass to energy. Even if scientists were ultimately able to achieve an energy gain using high energy levels, the gain would only amount to 20% or so. Accordingly, such technology is unproven and simply not worth the time, money, or energy.

The second approach has been referred to as “cold fusion” and has been branded as “junk science.” This approach dispenses with attempting to generate the same temperatures and pressures that exist in the sun. The scientists experimenting with “cold fusion” have seen some results indicating that fusion has been achieved. The results are inconclusive, however, and cannot be consistently replicated. The reason for the inconsistency may be because the scientists that have gotten the results do not understand the reasons for their success.

For example, Keith Johnson in his Environmental Capital blog for the Wall Street Journal commented on this fact in reviewing a presentation on 60 Minutes on Apr. 19, 2009, entitled “More Than Junk Science.” Mr. Johnson writes (available on the worldwide web at blogs.wsj.com/environmentalcapital/2009/04/20/cold-fusion-its-back-just-in-time-for-the-great-energy-debate):
Nobody is exactly sure what kind of reaction takes place among the lattice-work structure of the palladium that would explain the seemingly miraculous creation of excess heat and energy. That makes is hard, if not impossible, to determine when or how much energy should be created. And even if several laboratories have replicated to different degrees the experiment, the amounts of energy never seem to be the same, giving more ammunition to critics and confounding cold-fusion boosters.

Accordingly, we are currently spending billions of dollars on what is considered essential for green energy, but that could amount to incredibly wasteful spending. Therefore, there is a need for a method and system to achieve fusion in a consistent and repeatable manner, and as will be described in detail herein.

### SUMMARY OF THE INVENTION

Therefore, there is a need for a method and system that addresses the above and other problems to help solve our energy needs. The above and other problems are addressed by the exemplary embodiments of the present invention, which provide novel system and method for achieving an energy gain through fusion by removing electrons from hydrogen atoms prior to initiating fusion. This novel invention embodies a system and method that may be counterintuitive to scientific thinking. The novel system and method includes manufacturing hydrogen through an electrolysis unit using water as the source for hydrogen. After hydrogen is manufactured, electrons can be separated from the protons in the nucleus of the hydrogen atom by means of the photoelectric effect, heat, and/or a platinum catalyst in an ionization chamber. Once the protons are collected in a resting state in a proton collection chamber, electromagnetic radiation is directed onto the collected protons in a fusion chamber to achieve fusion. Thus, the novelty in obtaining such fusion includes a two-step process that involves not only the collection and gathering of protons close together, but also the utilization of an external energy source to initiate the fusion process. The external energy source can be at the same electromagnetic wave frequency that is given off as part of the fusion reaction in the stars. Such a fusion process can be used to accomplish an energy gain that produces heat that in turn can be utilized to produce work. For example, the heat generated can be used to turn a turbine to generate electricity, some of which may be used to run the electrolysis unit to keep the system and method running continuously, and the like.

Accordingly, in exemplary aspects of the present invention there is provided a system, method and apparatus for achieving an energy gain through fusion by removing electrons from a hydrogen atom prior to initiating fusion, including an electrolysis unit configured to manufacture hydrogen; an ionization chamber coupled to the electrolysis unit and configured to separate electrons from the manufactured hydrogen, wherein the electrons are separated from protons in a nucleus of a hydrogen atom; a proton collection chamber coupled to the ionization chamber and configured to collect the protons in a resting state; and a fusion chamber coupled to the proton collection chamber and configured to emit electromagnetic radiation on the collected protons to achieve fusion and an energy gain.

Still other aspects, features, and advantages of the present invention are readily apparent from the following detailed description, simply by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary system and method for achieving an energy gain through nuclear fusion and details some exemplary embodiments thereof;

FIG. 2 illustrates an exemplary ionization chamber of the system and method of FIG. 1, in which electrons are separated from protons for fusion to occur;

FIG. 3 illustrates an exemplary proton collection chamber of the system and method of FIG. 1, in which protons that have been separated from their electrons are held in a resting state, surrounded by a positively charged electric field, in preparation for fusion; and

FIG. 4 illustrates an exemplary fusion chamber of the system and method of FIG. 1, which is used as the receptacle where fusion can be accomplished through use of electromagnetic radiation.

### DETAILED DESCRIPTION OF THE PREFERRED EMBODIMENTS

A system and method for achieving an energy gain through fusion of hydrogen into helium is described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

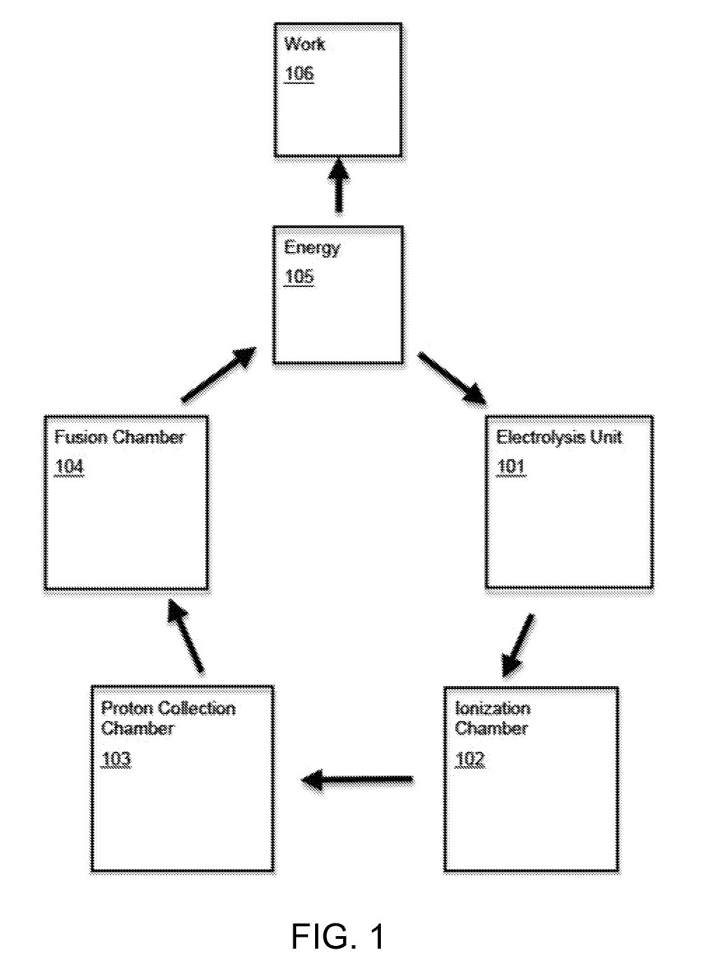

Referring now to the drawings, wherein like reference numerals designate identical or corresponding parts throughout the several views, and more particularly to FIG. 1 thereof, there is illustrated an exemplary system and method for achieving an energy gain through nuclear fusion and details some exemplary embodiments thereof. In FIG. 1, the components of the system can include a hydrogen source, which can be obtained from water through electrolysis in an electrolysis unit 101; an ionization chamber 102 where electrons can be separated from the protons in the nucleus of the hydrogen atom, for example, by means of the photoelectric effect, heat, and/or a platinum catalyst; (a) one or more vacuumized proton collection chambers 103 made of suitable insulating material, such as glass, ceramic, and the like. Two contained positively charged electric fields, one surrounding the collection chamber 103 to ensure containment of the protons and one to attract the electrons dispersed by the photoelectric effect can be employed. A fusion chamber 104 can include an electromagnetic radiation source to initiate the fusion process. For each additional proton collection chamber 103, an additional positively charged electric field can be employed. As a result of the fusion, energy 105 can be generated, which can produce work 106, for example, such as for making steam to generate electricity, for powering turbines, and the like. Some of the generated electricity can be used as the power source for the electrolysis unit 101.

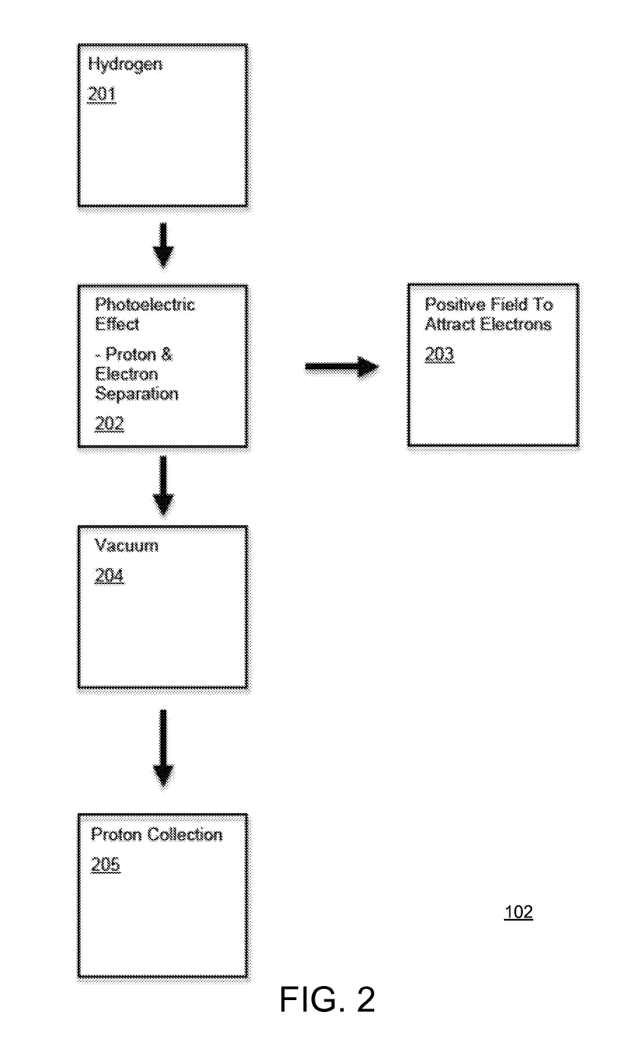

FIG. 2 illustrates the exemplary system and method with respect to the ionization chamber 102 from FIG. 1, in which the electrons are separated from the protons 202 for fusion to occur. In FIG. 2, the exemplary ionization chamber 102 utilizes the photoelectric effect. However, aside from the method outlined in FIG. 2, in further exemplary embodiments, the electrons can also be separated from the protons by means of heat or the use of a platinum catalyst, for example, as used in a hydrogen fuel cell, and the like, and as will be appreciated by those skilled in the relevant art(s).

In an exemplary embodiment, an acceptable way to separate the electrons from the protons is through the photoelectric effect, heat, a platinum catalyst, and the like, at step 202. The photoelectric effect is a phenomenon by which electrons are emitted from matter after the absorption of energy from electromagnetic radiation. The emitted electrons can be referred to as photoelectrons.

Accordingly, after the hydrogen atom is separated from water (H₂O) in the electrolysis unit 101, the hydrogen enters the ionization chamber 102 at step 201. The amount of hydrogen that enters the ionization chamber 102 can be controlled to ensure as close to 100 percent ionization, advantageously, so as not to waste energy. Hydrogen can be allowed to clear through the ionization chamber 102 to ensure that all impurities, such as oxygen, nitrogen, and the like, are removed.

The hydrogen atom should be at its lowest energy state (e.g., 13.6 eV) when it enters the ionization chamber 102. If the hydrogen atom is given an amount of energy at step 202 that is equivalent to the atom's ionization energy, the electrons can be completely removed from the influence of the nucleus. The Bohr model can be used to calculate the correct wavelength and energy of the photons that would have to be absorbed to ionize a neutral hydrogen atom in the gas phase. An electron can be ejected from the nucleus by using the correct wavelengths and intensity directed at the hydrogen atoms as it is electrolyzed and collected in the vacuumized proton collection chamber 103 at steps 204-205. The energy should excite the electrons, but not the nucleus of the atom. A positive charge at step 203 can be maintained near the ionization chamber 102 to ensure that the photoelectrons are removed from the area and do not reattach to another proton. The idea is to collect the protons in a suitable container made of any suitable insulating material, such as glass, ceramic, and the like, with as little energy as possible. The material used should be selected such that it readily gives up its electrons.

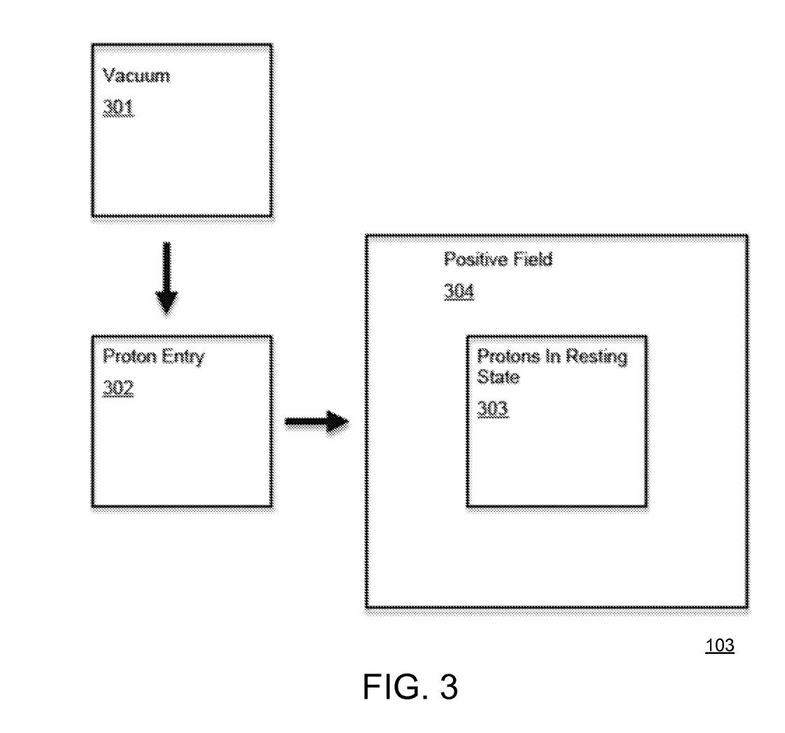

FIG. 3 illustrates the exemplary system and method with respect to the proton collection chamber 103 of FIG. 1. In FIG. 3, the protons that are collected in the vacuumized proton collection chamber 103 at steps 301-302 and that have been separated from their electrons are held in a resting state 303, surrounded by a positively charged electric field 304, in preparation for fusion.

Conventional scientific thinking dictates that the particles carrying the positive charges of the protons will repel, not attract each other. This thinking, however, may be incorrect. The positive charges of the proton can in fact attract one another. Magnetism is generally perceived to be bipolar, always having a north and south pole. Passing a coil of wire through a bipolar magnetic field creates an electric current. That electric current in turn establishes a magnetic field perpendicular to the electron flow. All individual atoms are magnetic monopoles (i.e., they behave as if they have only one pole). Contrary to what one might think, a monopole displays magnetic attraction for its similarly charged protons and also displays repulsion for opposite charged electrons. A monopolistic magnetic attraction is employed to obtain fusion.

Potential outcomes from the exemplary system and method can include the following. First, it may not be possible to effectively prevent the protons regaining the neutrality of charge. Second, the protons may keep increasing their kinetic energy due to repulsion, which can automatically bring about fusion if there is sufficient containment due to charge or pressure (e.g., where such scenario may abuse the laws of thermodynamics). Third, the protons may quietly collect in sufficient density because of the monopolistic attraction as opposed to the electrostatic repulsion of the positive charges, as further described with respect to the exemplary system and method and the embodiments thereof.

The less heat and energy used to segregate the protons and electrons in the ionization chamber 102, the easier it can be to achieve fusion, because the protons can be collected in the collection chamber 103 in a state of low energy and movement. Glass can be used for the proton collection chamber because it is a good insulator and can give up electrons easily, so that a positive charge can be maintained. The proton collection chamber 103 can be purged of impurities, for example, by providing a suitable vacuum at step 301. The vacuum can make it easier for the proton collection chamber 103 to draw the protons therein for entry of the protons at step 302. The proton collection chamber 103 can be configured to have as much of a positive charge 304 as possible surrounding it.

A moving charge carries a magnetic field and can be contained by magnets. Since the protons gathered in the proton collection chamber 103 may not be moving in one consistent direction, they may not be contained by a magnetic field. Thus, an electric field 304 can be used to contain the protons. These protons should be at their at a resting state 303, as will be appreciated by those skilled in the relevant art(s), and should take up much less space in the proton collection chamber 103 than a hydrogen atom would. Therefore, one can get a lot more proton weight in the proton collection chamber 103 or a given space. The only movement should be the kinetic back and forth movement of the protons.

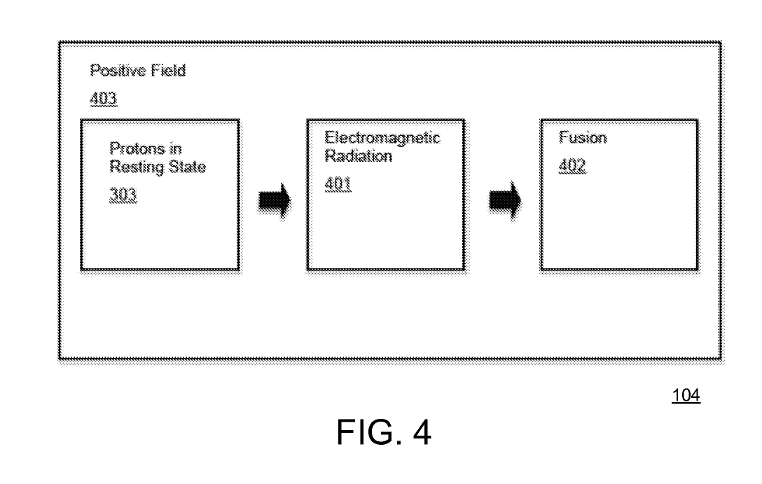

FIG. 4 illustrates the exemplary system and method with respect to the exemplary fusion chamber 104 of FIG. 1, which is used as the receptacle where fusion can be accomplished through the use of electromagnetic radiation at step 401. In some embodiments, the fusion chamber 104 can be the same receptacle as the proton collection chamber 103, except that it is used for the purpose of fusion. In FIG. 4, once the protons are collected, they should stay in close proximity with one another in the resting state 303, as will be appreciated by those skilled in the relevant art(s), but they should not fuse on their own. This is because achieving fusion employs a two-step process, which involves not only the collection and gathering of protons close together, but also employing an external energy source to initiate the fusion process.

A force is needed to cause an implosion so that fusion can occur. For example, in a hydrogen bomb, an atom bomb surrounds the hydrogen component of the bomb. The atom bomb is detonated first, the x-rays from which then cause the hydrogen component of the bomb to implode.

The idea is to keep the fusion chamber with as high a positive charge 403 to contain the protons, and then strategically directing selective electromagnetic radiation at the protons at step 401 in the proton collection chamber 103 to create energy that can cause the protons to fuse at step 402.

Once fusion is achieved, a number of devices and subsystems of the exemplary embodiments can be utilized. For example, heat created through fusion can be used to create steam, which can in turn be used to run a turbine, and the like, to generate clean, renewable, and inexpensive electricity 106, some of which can be used to run the electrolysis unit 101, so as to run the system and method continuously, as well as do any other suitable work.

The above-described system and method and devices and subsystems of the exemplary embodiments, for example, can be used to generate energy that can be used for any and all suitable purposes. For example, fusion can be used to produce heat, which can in turn be used to make steam to generate electricity. The electricity can be transported through a power grid to end users, who can use the electricity for the same purposes they use it today, as will be appreciated by those skilled in the relevant art(s).

The above-described system and method, for example, can also be used to provide inexpensive electricity to end users, who may already have home electrolysis units to produce hydrogen for hydrogen powered vehicles and which can be used as part of the exemplary system and method. End users can also use the inexpensive electricity to recharge batteries of electric cars, and the like. Thus, the exemplary embodiments are suitable to a wide variety of purposes and applications, as will be appreciated by those skilled in the relevant art(s).

While the present invention has been described in connection with a number of exemplary embodiments and implementations, the present invention is not so limited, but rather covers various modifications and equivalent arrangements, which fall within the purview of the appended claims.

What is claimed is:

1. A system for achieving an energy gain through fusion by removing electrons from a hydrogen atom prior to initiating fusion, the system comprising:
an electrolysis unit configured to manufacture hydrogen from water;
an ionization chamber coupled to the electrolysis unit and configured to separate electrons from the manufactured hydrogen, wherein the electrons are separated from protons in a nucleus of a hydrogen atom;
a proton collection chamber coupled to the ionization chamber and configured to collect the protons in a resting state; and
a fusion chamber coupled to the proton collection chamber and configured to emit electromagnetic radiation on the collected protons to achieve fusion and an energy gain.

2. The system of claim 1, wherein the fusion chamber is further configured with a positive charge to contain the protons therein and the electromagnetic radiation is directed at the collected protons to create energy to cause the collected protons to fuse and provide the energy gain.

3. The system of claim 1, wherein the electrons are separated from the protons in the nucleus of the hydrogen atom using at least one of a photoelectric effect, heat, and a platinum catalyst.

4. A method for achieving an energy gain through fusion by removing electrons from a hydrogen atom prior to initiating fusion, the method comprising:
manufacturing hydrogen from water with an electrolysis unit;
separating electrons from the manufactured hydrogen with an ionization chamber coupled to the electrolysis unit, wherein the electrons are separated from protons in a nucleus of a hydrogen atom;
collecting the protons in a resting state with a proton collection chamber coupled to the ionization chamber; and
emitting electromagnetic radiation on the collected protons to achieve fusion and an energy gain with a fusion chamber coupled to the proton collection chamber.

5. The method of claim 4, wherein the fusion chamber is further configured with a positive charge to contain the protons therein and the electromagnetic radiation is directed at the collected protons to create energy to cause the collected protons to fuse and provide the energy gain.

6. The method of claim 4, wherein the electrons are separated from the protons in the nucleus of the hydrogen atom using at least one of a photoelectric effect, heat, and a platinum catalyst.

8. An apparatus for achieving an energy gain through fusion by removing electrons from a hydrogen atom prior to initiating fusion, the apparatus comprising at least one of:
an electrolysis unit configured to manufacture hydrogen from water;
an ionization chamber coupled to an electrolysis unit and configured to separate electrons from manufactured hydrogen, wherein the electrons are separated from protons in a nucleus of a hydrogen atom;
a proton collection chamber coupled to an ionization chamber and configured to collect protons in a resting state; and
a fusion chamber coupled to a proton collection chamber and configured to emit electromagnetic radiation on collected protons to achieve fusion and an energy gain.

9. The apparatus of claim 8, wherein the fusion chamber is further configured with a positive charge to contain the protons therein and the electromagnetic radiation is directed at the collected protons to create energy to cause the collected protons to fuse and provide the energy gain.

10. The apparatus of claim 8, wherein the electrons are separated from the protons in the nucleus of the hydrogen atom using at least one of a photoelectric effect, heat, and a platinum catalyst.
